(19) United States
(12) Patent Application Publication
(10) Pub. No.: US 2006/0234730 A1
(43) Pub. Date: Oct. 19, 2006

(54) System and method for accessing multiple data sources by mobile applications

(75) Inventors: Viera Bibr, Kilbride (CA); Brindusa Fritsch, Toronto (CA); Michael Shenfield, Richmond Hill (CA)

Correspondence Address: Gowling Lafleur Henderson LLP, 2600-160 Elgin Street, Ottawa, ON, K1P 1C3, CA

(73) Assignee: Research In Motion Limited

(21) Appl. No.: 11/290,542

(22) Filed: Dec. 1, 2005

Related U.S. Application Data
(60) Provisional application No. 60/672,054, filed on Apr. 18, 2005.

(51) Int. Cl. H04Q 7/20; H04M 1/00

(52) U.S. Cl. 455/466; 455/552.1

(57) ABSTRACT

A system for accessing multiple data sources by mobile applications, the system comprising an application gateway server including a message broker for communicating between the system and a mobile device and a message transformer for communicating with a plurality of backend servers having different data source infrastructures. A method of configuring an application gateway server for accessing multiple data sources by mobile applications, the method comprising the steps of acquiring a desired application bundle, building a communication model in dependence upon the desired application bundle, retrieving a list of data sources from the application bundle, and generating a mapping of data source to a connector type and data structure. A method of accessing multiple data sources by mobile applications, the method comprising the steps of determining a required data structure for a received message, building a representation in dependence upon the required data structure, acquiring a corresponding connector type, and accessing a data source associated with the connector type.

This non-provisional application claims the benefit of U.S. Provisional Application No. 60/672,054 filed Apr. 18, 2005.

The present patent disclosure relates generally to a system and method for accessing multiple data sources by mobile applications.

### BACKGROUND OF THE INVENTION

With the emerging importance of Web services in the IT business, more and more IT players are providing a standardized access to their business through Web services technology. However, in the IT landscape there are still a large number of applications not exposing information through Web services, but relying instead on other data sources: databases, CORBA applications, etc.

Mobile applications can be used for integrating various data sources. However, the traditional development cycle of such applications is highly impacted by the nature of the data sources the wireless application communicates with. The connection infrastructure to a specific data source (database, Web service, etc) has to be built inside the wireless application itself, consuming valuable resources.

Systems and methods disclosed herein provide a system and method for accessing multiple data sources by mobile applications to obviate or mitigate at least some of the aforementioned disadvantages.

### BRIEF DESCRIPTION OF THE DRAWINGS

An embodiment of the patent disclosure will now be described by way of example only with reference to the following drawings in which:

FIG. 1 is block diagram of a network facilitating wireless component applications;

FIG. 2 is a detailed block diagram of the application gateway shown in FIG. 1;

FIG. 3 is a block diagram of a wireless component application communication model;

FIG. 4 is a flow diagram of a communication sequence for the Wireless component application communication model of FIG. 3;

FIG. 5 is a flow diagram of preparing the network as shown in FIG. 1 for accessing multiple data sources by mobile applications in accordance with an embodiment of the present patent disclosure;

FIG. 6 is a flow diagram of retrieval of data in a network as shown in FIG. 1 for accessing multiple data sources by mobile applications in accordance with an embodiment of the present patent disclosure; and

FIG. 7 is a detailed block diagram of the network corresponding to the flow diagram of FIG. 6.

### DETAILED DESCRIPTION OF THE PREFERRED EMBODIMENT

This patent disclosure enables wireless applications built from various data source schemas to communicate with those data sources in a generic, automatic fashion, without the need to rewrite or deploy application specific communication software.

In accordance with an aspect of the present patent disclosure there is provided a system for accessing multiple data sources by mobile applications, the system comprising an application gateway server including a message broker for communicating between the system and a mobile device and a message transformer for communicating with a plurality of backend servers having different data source infrastructures.

In accordance with an aspect of the present patent disclosure there is provided a method of configuring an application gateway server for accessing multiple data sources by mobile applications, the method comprising the steps of acquiring a desired application bundle, building a communication model in dependence upon the desired application bundle, retrieving a list of data sources from the application bundle, and generating a mapping of data source to a connector type and data structure.

In accordance with an aspect of the present patent disclosure there is provided a method of accessing multiple data sources by mobile applications, the method comprising the steps of determining a required data structure for a received message, building a representation of the data in dependence upon the required data structure, acquiring a corresponding connector type, and accessing a data source associated with the connector type.

The present patent disclosure provides a method and a system for a mobile application to orchestrate communication with multiple data sources via a single proxy server. The mobile application aggregates (through additional mapping information bundled with it at development time) a subset of the referred to data source external interfaces into one model that forms its own communication model. The mobile application communication model is described as a collection of incoming and outgoing messages mapped to respective operations or functions present in the data source external interface. A proxy server is used to generically map mobile application communication needs to multiple data source infrastructures deployed at different locations and with different connection methods. The mobile application bundle contains all the information necessary for the proxy server to determine at runtime, for the request received wirelessly from the mobile device, which connection method to use to connect to the data source, which endpoint to connect to and what are the appropriate connectivity parameters, such as user credentials.

Conveniently, embodiments rely on XML as a standard method for the description of the mapping between application communication model and data source as well as connectivity information. Implementations are provided by an application tool that can generate an application bundle containing the mapping and data source connection information. A proxy server using specialized generic connectors for various data sources that can be described by a schema (for example but not limited to Web services, DB) The proxy server, via its mapping engine, allows seamless funneling of application data from the individual mobile application to the correct data source and vice versa (different endpoint per operation). Additionally, the proxy server, via its specialized connectors, enables data to be delivered to various backend infrastructures via different network and connectivity protocols (i.e., different connector or connection method).

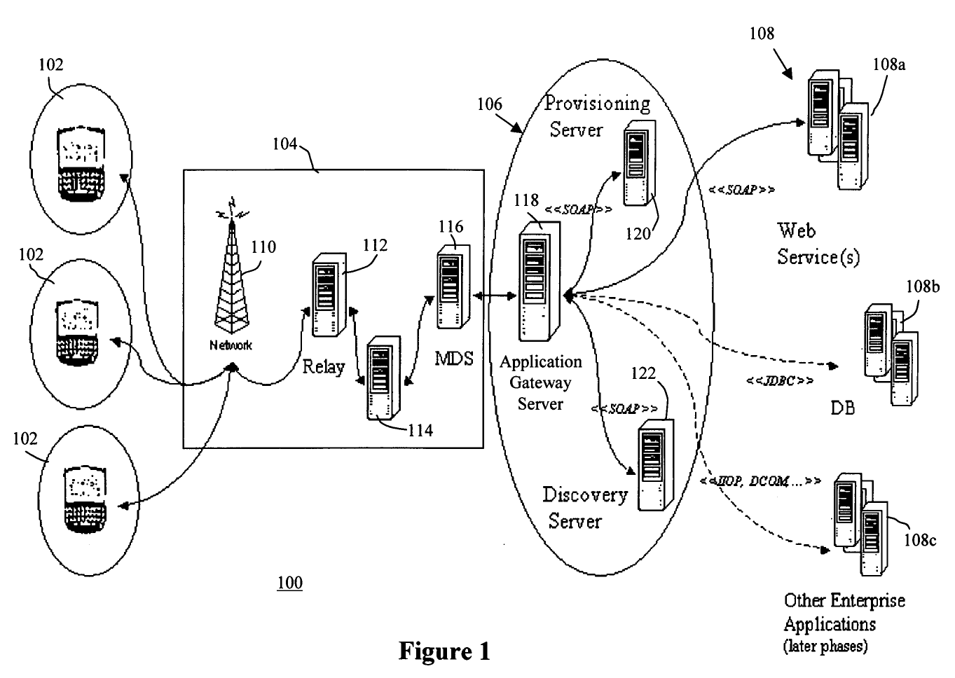

For convenience, like numerals in the description refer to like structures in the drawings. Referring to FIG. 1, a communication infrastructure is illustrated generally by numeral 100. The communication infrastructure 100 comprises a plurality of wireless devices 102, a communication network 104, an application gateway 106, and a plurality of backend services 108.

The wireless devices 102 are typically personal digital assistants (PDAs), such as a BlackBerry™ by Research in Motion for example, but may include other devices. Each of the wireless devices 102 includes a runtime environment capable of hosting a plurality of component applications.

Component applications comprise one or more data components, presentation components, and/or message components, which are written in a structured definition language such as Extensible Markup Language (XML). The component applications can further comprise workflow components which contain a series of instructions such as written in a subset of ECMAScript, and can be embedded in the XML in some implementations. Therefore, since the applications are compartmentalized, a common application can be written for multiple devices by providing corresponding presentation components without having to rewrite the other components. Further, large portions of the responsibility of typical applications are transferred to the runtime environment for component application. The details of the component applications are described at the end of this description.

The wireless devices 102 are in communication with the application gateway 106 via the communication network 104. Accordingly, the communication network 104 may include several components such as a wireless network 110, a relay 112, a corporate server 114 and/or a mobile data server 116 for relaying data between the wireless devices 102 and the application gateway 106.

The application gateway 106 comprises a gateway server 118, a provisioning server 120 and a discovery server 122. The gateway server 118 acts as a message broker between the runtime environment on the wireless devices 102 and the backend servers 108. The gateway server 118 is in communication with both the provisioning server 120 and the discovery server 122. The gateway server 118 is further in communication with a plurality of the backend servers 108, such as Web services 108a, database services 108b, as well as other enterprise services 108c, via a suitable link. For example, the gateway server 110 is connected with the Web services 108a and database services 108b via Simple Object Access Protocol (SOAP) and Java Database Connectivity (JDBC) respectively. Other types of backend servers 108 and their corresponding links will be apparent to a person of ordinary skill in the art.

Each wireless device 102 is initially provisioned with a service book establishing various protocols and settings, including connectivity information for the corporate server 114 and/or the mobile data server 116. These parameters may include a Uniform Resource Locator (URL) for the application gateway server 118 as well as its encryption key. Alternately, if the wireless device 102 is not initially provisioned with the URL and encryption key, they may be pushed to the wireless device 102 via the mobile data server (MDS)116. The mobile device 102 can then connect with the application gateway 106 via the URL of the application gateway server 118.

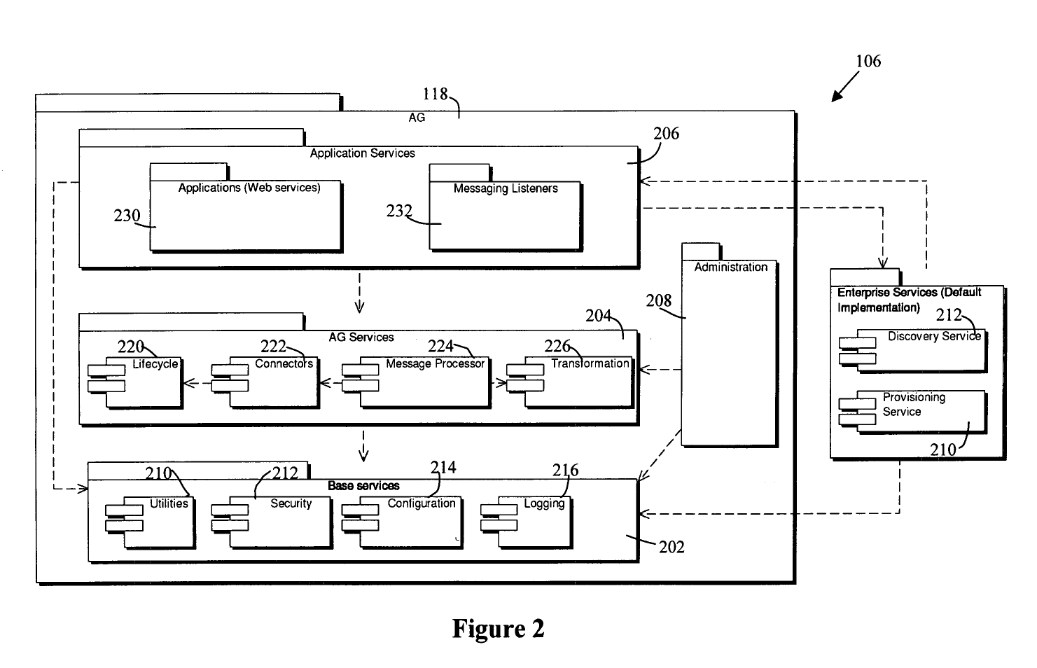

Referring to FIG. 2, a more detailed view of the application gateway 106 is shown. The application gateway server 118 includes three layers of service; a base services layer 202, an application gateway services layer 204 and an application services layer 206. The application gateway server 118 further includes an administration service 208.

A provisioning service 210 and a discovery service 212 are provided by the provisioning server 120 and discovery server 120, respectively.

At the lowest level, the base services layer 202 offers basic, domain independent system services to other components in higher levels. Thus, for example, all subsystems in the application gateway services layer 204 and the application services layer 206 can utilize and collaborate with the subsystems in the base services layer 202. In the present embodiment, the base services layer 202 includes a utilities subsystem 210, a security subsystem 212, a configuration subsystem 214, and a logging subsystem 216.

The application gateway services layer 204 provides wireless component application domain specific services. These services provide efficient message transformation and delivery to backend systems 108 and provide wireless device 102 and component application lifecycle management. In the present embodiment, the application gateway services layer 204 includes a lifecycle subsystem 220, a connector subsystem 222, a messaging subsystem 224, and a transformation subsystem 226.

The application services layer 206 sits at the top of the architecture and provides external program interfaces and user interfaces using subsystems provided by the lower layers. For example, various applications such as a service provider lifecycle application, a packaging application and a message listening application provide external program interfaces since they communicate primarily with applications on external systems. Similarly, an administration application provides a user interface by providing a user with ability to access and potentially modify application gateway data and/or parameters.

The administration service 208 is responsible for administrative system messages, administration of the wireless devices 102, runtime administration of the application gateway subsystems, support and display system diagnostics, and administration of default implementations of the provisioning and discovery services.

The messaging listening application provides an interface for receiving messages from the wireless devices 102 as well as external sources and forwarding them to the messaging subsystem. Further, the message listening application typically authenticates that the source of the message is valid.

The security subsystem 212 providing services used by other subsystems for securing communications with the wireless device 102. In order to facilitate secure communications, the security subsystem 212 encrypts and decrypts messages, validates signatures and signs messages.

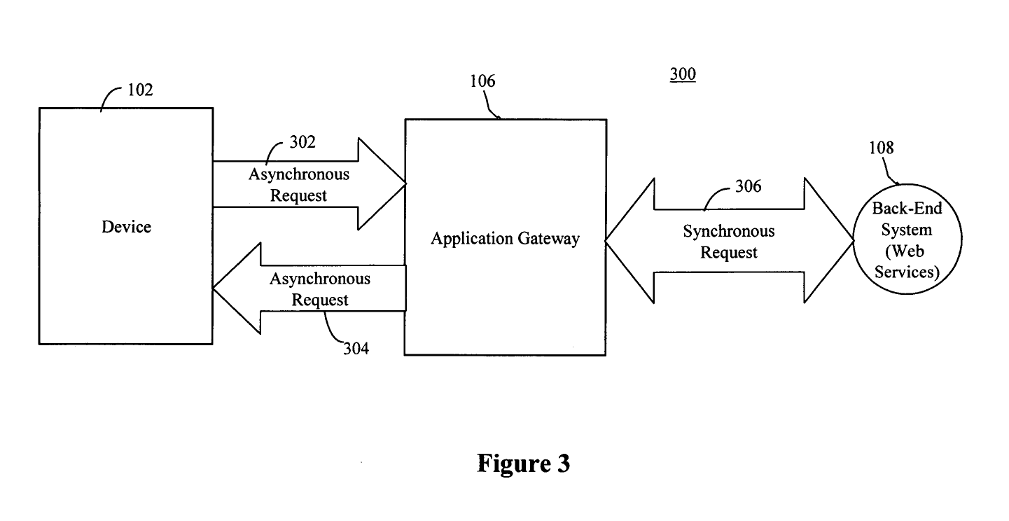

Referring to FIG. 3 there is illustrated in a block diagram a Wireless component application communication model. From a high level perspective, the overall Wireless component application infrastructure 300 includes a Wireless component application runtime environment (Device RE) running on the device 102 and a Wireless component application gateway (AG) 106 running on the server 118.

The Application Gateway (AG) 106 serves as a mediator between a wireless component application (Wiclet) executed by RE 102 and a one or more back-end systems 108 with which the Wiclet communicates. In most cases the back-end system(s) 108 is expected to be a Web service using SOAP over HTTP or HTTPS as transport protocol.

The term Web service is used interchangeable with back-end throughout this document since Web services are the most common expected back-end systems. The Wireless component application communication model 300 is based upon an asynchronous messaging paradigm. In this model the application gateway (AG) 106 establishes and mediates the connection between the device 102 and the back-end system(s) 108 to:

1. Achieve greater flexibility in resource management.

2. Provide reliable communication link between device 102 and back-end systems 108 to handle situations when wireless coverage is unstable.

3. Efficiently distribute workload between device RE 102 and AG 106.

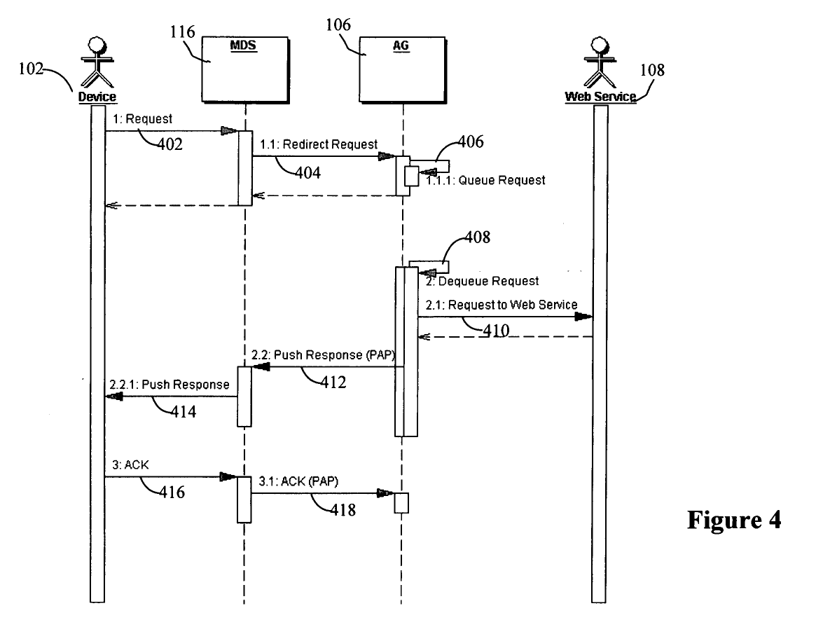

Referring to FIG. 4 there is illustrated in a flow diagram of a communication sequence for the Wireless component application communication model of FIG. 3. The diagram describes the communications sequence between the device 102 and the back-end system(s) 108:
Upon receiving a request 402 from the device 102, via 404 MDS 116, AG 106 queues the request 406 and releases the connection to the device.
Next, the request is retrieved from the queue 408, pre-processed and forwarded 410 to the Web service 108 through a synchronous communication channel.
Any response from the previous request is processed by AG 106 and a response message is sent asynchronously 412 and 414 back to the device.

The Rapid Application Development Tool (RAD tool) generates an application bundle having the following structure:

Application Bundle Contents

Mobile Application Definition
Mobile Application Index of Data Sources
Mobile Application Data Source Definitions
Mobile Application Communication Mapping per Data Source
Mobile Application Connectivity Information (service Descriptor) per Data Source

Mobile Application Definition—The application definition is the XML representation of the application, containing a data model (data types), a visual model (screens, layouts, menus, controls), a communication model (messages) and other resources. The communication model of the application aggregates the use of various data sources on the server side. To the runtime environment, the application communication is uniformly handled as if it is with just one data source.

Mobile Application Index of Data Sources—This is a list of the Data Sources participating in the application. The list refers to the Data Source Definitions also included in the bundle.

Mobile Application Data Source Definitions—The application bundle contains one definition per Data Source. This defines the Data Source communication model (external API) and the data types used by it.

Mobile Application Communication Mapping—The application communication mapping defines the association between the application communication model and the data source communication model that needs to be used in order to effectively map the application data at runtime.

Mobile Application Connectivity Information (service Descriptor)—The service Descriptor contains information (e.g., credentials) necessary to connect to the Data Source in order to enable data flow (update Data Source, retrieve data from Data Source).

Data Source Mapping Loading Process—During application upload (installation) to a particular device, some portions of the application bundle are loaded by the proxy server and stored locally. The proxy server will later use this information at runtime, to serve the mobile application communication with the various data sources that it was built to communicate with.

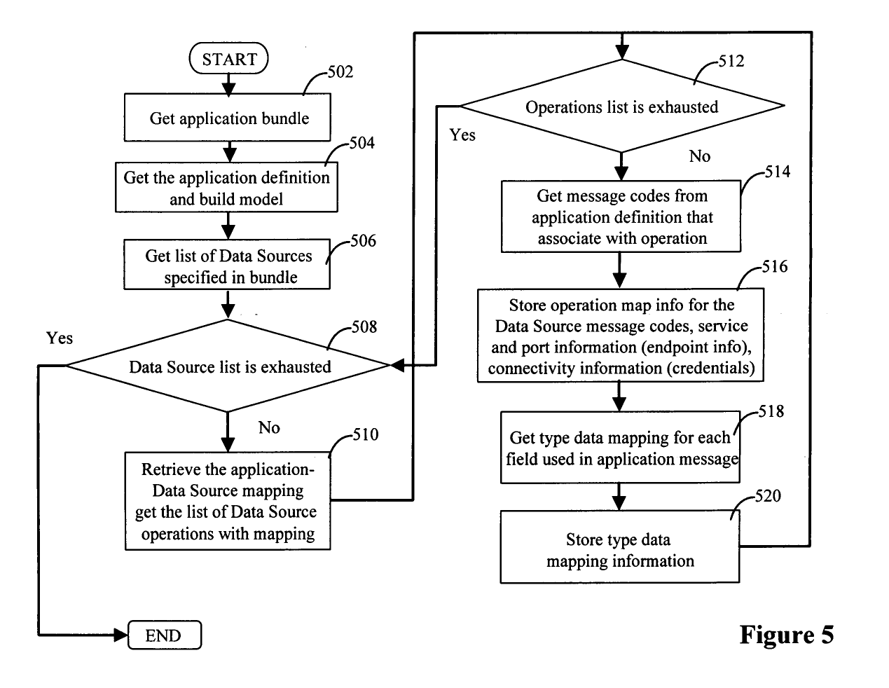

Referring to FIG. 5, there is a flow diagram for preparing the network as shown in FIG. 1 for accessing multiple data sources by mobile applications in accordance with an embodiment of the present patent disclosure. The process of FIG. 5 starts by getting in step 502 the application bundle. This is followed by getting in step 504 the application definition and building the model and getting in step 506 the list of Data Sources specified in the bundle. Next it is determined in step 508 whether the Data Source list is exhausted. If not, in step 510 the process retrieves the application-Data Source mapping and gets the list of Data Source operations with mapping; the process ends if the Data Source list is exhausted. Continuing from step 510, it is determined in step 512 whether the Operations list is exhausted. If not, in step 514 the process gets message codes from the application definition associated with the operation; otherwise the process ends. Continuing from step 514, in step 516, the process stores operation map information for the Data Source message codes, service and port information (endpoint information), and connectivity information (credentials). Next, in step 518, the process gets the type data mapping for each field used in the application message. Finally, in step 520, the process stores the type data mapping information and then proceeds back to step 512.

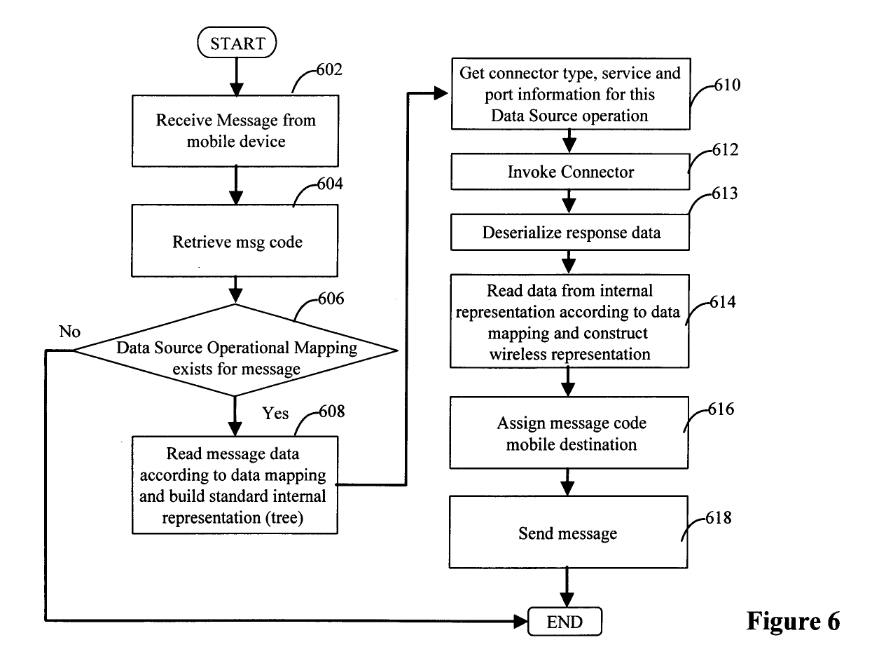

Referring to FIG. 6 there is illustrated in a flow diagram of retrieval of data in a network as shown in FIG. 1 for accessing multiple data sources by mobile applications in accordance with an embodiment of the present patent disclosure.

The process starts with the application gateway receiving a message from a mobile device 102 in step 602, retrieving a message code in step 604, and determining in step 606 if a Data Source Operation Mapping exists for the message. If yes, then the process reads message data according to the data mapping and builds a standard internal representation (tree) in step 608, gets the connector type and the service and port information for this Data Source operation in step 610, invokes the appropriate connector in step 612, deserializes response data into an internal representation in step 613, reads data from internal representation according to the data mapping and constructs a wireless representation in step 614, assigns a message code mobile destination in step 616, and sends the message in step 618.

Thus in operation, during application execution on the mobile device 102, the application gateway retrieves data from backend infrastructures 108 or sends data to backend infrastructures 108 to update their data source. The messages communicated by mobile device 102 are compacted in a form that is optimized for traffic through a wireless network 104.

The application gateway finds the Data Source operation that is associated with the message and finds the mapping necessary to correctly read the message, de-compacts the wireless message, builds a standard, internal representation of the data, then generically routes the flow to the appropriate connector. The application gateway uses specified connectivity information for this Data Source (service Descriptor) to connect and communicate the data.

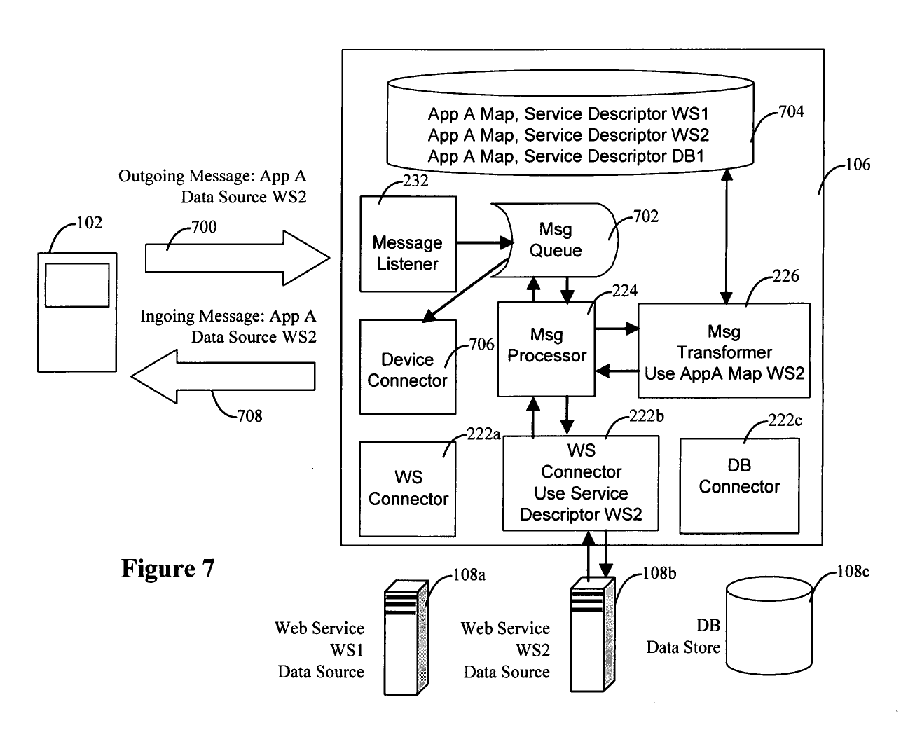

Referring to FIG. 7 there is illustrated a detailed block diagram of the network corresponding to the flow diagram of FIG. 6.

FIG. 7 depicts the architecture of a proxy server system, the application gateway, that is able to generically invoke various data sources.
1. Incoming message 700 for Application A, Data Source WS1 is received by the application gateway 106 through a Message Listener 232.
2. The Message Listener 232 queues 702 the message and releases the connection to mobile device.
3. A Message Processor 224 picks up message from queue 702 and forwards to Message Transformer 226.
4. Message Transformer 226 retrieves 704 the Data Source operation map and service Descriptor based on message code.
5. Message Transformer 226 reads the message according to map.
6. Message Transformer 226 builds an internal representation of the message data.
7. Message Processor detects connector to use and passes data and connectivity information to specific connector instance 222b
8. Connector 222b connects to Data Source 108b and passes the data.
9. Connector 222b retrieves any result data and queues it.
10. Processor 224 takes data and passes to transformer 226 for compaction
11. Transformer 226 builds compact message
12. Processor 224 passes message built by transformer 226 to device connector 706.

Numerous modifications, variations and adaptations may be made to the particular embodiments described above without departing from the scope patent disclosure, which is defined in the claims.

What is claimed is:

1. A system for accessing multiple data sources by mobile applications, the system comprising:
an application gateway server including a message broker for communicating between the system and a mobile device and a message transformer for communicating with a plurality of backend servers having different data source infrastructures.

2. The system of claim 1, wherein the message transformer includes a database for mapping each data source to a desired data structure.

3. The system of claim 1, wherein the application gateway server includes a plurality of connectors corresponding to a plurality of data source infrastructures.

4. The system of claim 3, wherein the plurality of connectors includes a Web service connector.

5. The system of claim 3, wherein the plurality of connectors includes a database connector.

6. A method of accessing multiple data sources by mobile applications, the method comprising the steps of:
(a) determining a required data structure for a received message;
(b) building a representation in dependence upon the required data structure;
(c) acquiring a corresponding connector type; and
(d) accessing a data source associated with the connector type.

7. The method of claim 6, wherein the step of accessing includes the step of reading data from the representation in dependence upon a data mapping.

8. The method of claim 6, wherein the step of accessing includes the step of connecting to the data source using the acquired credentials and transmitting the data.

9. The method of claim 6, wherein the step of determining includes the step of retrieving a message code.

10. The method of claim 6, wherein the step of determining includes the step of accessing a data source mapping for the message code.

11. The method of claim 6, wherein the step of determining includes the step of reading message data in dependence upon the data source mapping

12. The method of claim 6, wherein the step of acquiring includes the step of retrieving a connector type.

13. The method of claim 6, wherein the step of acquiring includes the step of retrieving service information.

14. The method of claim 6, wherein the step of acquiring includes the step of retrieving port information.

15. A method of configuring an application gateway server for accessing multiple data sources by mobile applications, the method comprising the steps of:
(a) acquiring a desired application bundle;
(b) building a communication model in dependence upon the desired application bundle;
(c) retrieving a list of data sources from the application bundle; and
(d) generating a mapping of each data source to a connector type and data structure.
